(19) United States
(12) Patent Application Publication
(10) Pub. No.: US 2009/0210333 A1
(43) Pub. Date: Aug. 20, 2009

(54) MICRO-LICENSING OF COMPOSITE CONTENT

(75) Inventors: Tobin R. Titus, Issaquah, WA (US); Ernest A. Booth, Bellevue, WA (US); Erik Porter, Kirkland, WA (US); Boyd C. Multerer, Redmond, WA (US); Lili Cheng, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/031,687

(22) Filed: Feb. 14, 2008

(51) Int. Cl. G06Q 20/00

(52) U.S. Cl. 705/35

(57) ABSTRACT

Technologies are described herein for compensating multiple contributing participants in a virtual world. A license associated with a composite content item is received upon a sale, rental, or lease of the composite content item to a purchasing participant in the virtual world. At least a first contributing participant and a second contributing participant are identified in a participant list within the license. Compensation is provided to the first contributing participant and the second contributing participant in accordance with the participant list.

### BACKGROUND

In recent years, massively multiplayer online (“MMO”) computer applications, such as massively multiplayer role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

One significant factor in the growth of MMO computer applications has been the ability for participants to create and distribute their own content to other participants within the MMO environment. Common types of user-generated content include multimedia files, such as text, picture, audio, and video files, as well as application plug-ins that may be utilized within a MMO computer application to provide additional functionality. An example of an application plug-in may be a graphical user interface (“GUI”) embedded within a social networking website that enables participants of the website to rate movies. In MMO environments, user-generated content may also include avatars and three-dimensional virtual objects, such as cars, buildings, and the like.

In some instances, a user-generated content item is a composite work containing contributions from multiple users. An example of a composite work may be a virtual home. A first user may generate the floor plan for the virtual home. A second user may furnish the virtual home, and a third user may provide the external landscaping surrounding the virtual home. After each user has completed his or her corresponding portion of the virtual home, the virtual home may be sold as a composite work to other users. However, there does not currently exist a way to compensate the individual users for their contributions to the composite work.

It is with respect to these considerations and others that the disclosure made herein is presented.

### SUMMARY

Technologies are described herein for compensating multiple contributing participants in a virtual world. In particular, through the utilization of the technologies and concepts presented herein, each of the contributing participants is compensated upon the sale, rental, or lease of a composite content item in accordance with micro-licensing language in a license. As used herein, the micro-licensing language refers to a portion of the license that identifies the contributing participants to be compensated. The micro-licensing language may also provide rules defining how content can be used, rented, sold, and the like. The contributing participants may each be responsible for the generation and/or maintenance of at least a portion of the composite content item, including several nested portions of composite content. The contributing participants may be compensated in accordance with the micro-licensing language in the license associated with the composite content item.

According to one aspect presented herein, a computer program is provided for compensating multiple contributing participants in a virtual world. The computer program receives a license associated with a composite content item upon a sale, rental, or lease of the composite content item to a purchasing participant in the virtual world. The computer program identifies at least a first contributing participant and a second contributing participant in a participant list within the license. The computer program provides compensation to the first contributing participant and the second contributing participant in accordance with the participant list.

It should be appreciated that although the features presented herein are described in the context of a MMO computer application, these features may be utilized with any type of virtual world or environment including, but not limited to, other types of games as well as online social communities. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world;

FIG. 2 is a screen display diagram showing an illustrative screenshot of a virtual store within the virtual world, in accordance with one embodiment;

FIG. 3 is a diagram showing an illustrative portion of micro-licensing language, in accordance with one embodiment;

FIG. 4 is a flow diagram showing an illustrative process for enforcing micro-licensing language for compensating multiple contributing participants, in accordance with one embodiment; and

FIG. 5 is a computer architecture diagram showing aspects of an illustrative computer hardware architecture for a computing system capable of implementing the embodiments presented herein.

### DETAILED DESCRIPTION

The following detailed description is directed to technologies for generating and enforcing micro-licensing language for compensating multiple contributing participants in a virtual world. Through the utilization of the technologies and concepts presented herein, each virtual world participant who contributes to generating, maintaining, and/or otherwise providing a composite content item may be specified within the micro-licensing language of a license associated with the composite content item. When another participant purchases, rents, or leases the composite content item, the participants included within the micro-licensing language are compensated according to the micro-licensing language of the license.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

Solely for illustrative purposes, the micro-licensing language is described herein in the context of a virtual world. Further, the micro-licensing language is described herein with reference to composite content items created by multiple participants of the virtual world. It should be appreciated that the micro-licensing language is not so limited and may be utilized in a variety of other contexts and with other types of content. In particular, the micro-licensing language may be utilized with any content that is distributed through a content and/or service provider. Examples of content may include, but are not limited to, multimedia content, such as text, pictures, audio, video, and combinations thereof, as well as computer applications, such as application plug-ins that add new functionality to the content and/or service provider. Other examples of content include avatars, three-dimensional virtual objects, and scripts (i.e., small computer programs). Examples of content and/or service providers may include, but are not limited to, social network websites (e.g., FACEBOOK from FACEBOOK INCORPORATED) and multimedia distribution services (e.g., ZUNE MARKETPLACE from MICROSOFT CORPORATION, ITUNES from APPLE INCORPORATED).

As used herein, the term “virtual world” refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world is generally inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. The avatars and the virtual objects utilized in the virtual world may or may not be animated images.

As used herein, a “contributing participant” refers to a participant of the virtual world who contributes to the generation and/or maintenance of a composite content item or otherwise provides a portion of the composite content item. A “composite content item” refers to a content item containing multiple portions created by two or more participants of the virtual world. Individual portions may also be created by two or more participants. A “purchasing participant” refers to a participant who purchases, rents, or leases a composite content item. A given participant may be a contributing participant with regards to one composite content item, and a purchasing participant with regards to another composite content item. Also as used herein, “micro-licensing language” refers to at least a portion of a license that specifies the contributing participants for a given composite content item. The micro-licensing language may also define the amount of compensation to be provided to the contributing participants.

According to exemplary embodiments, each contributing participant is included within the micro-licensing language of a machine-readable and enforceable license. In particular, the micro-licensing language may include, for each composite content item, a content generation list containing each contributing participant for the given composite content item. Since each contributing participant may contribute different amounts to the generation and/or maintenance of the composite content item, each contributing participant may be associated with a weighting, which defines the amount of compensation to be provided upon the sale, rental, or lease of the composite content item.

When a purchasing participant purchases, rents, or leases the composite content item, each contributing participant may be compensated according to the micro-licensing language of the license. The micro-licensing language may be associated with a purchased, rented, or leased composite content item. In one embodiment, the micro-licensing language includes a participant list and an allocation guideline. The participant list may specify the contributing participants associated with the purchased, rented, or leased composite item. As such, the participant list may specify the contributing participants who are compensated upon the sale, rental or lease of the composite content item. Further, the allocation guideline may specify the amount of compensation to be provided to each of the contributing participants. Examples of the allocation guideline may include a predetermined amount of compensation or a percentage of an overall amount.

In one embodiment, the participant list and the allocation guideline may be dynamic. New contributing participants may be dynamically added to the participant list and former contributing participants may be dynamically removed from the participant list. For example, if a new contributing participant provides an improvement to an existing composite content item, the new contributing participant may be added to the participant list. Additionally, if the portion of the composite content item generated by a former contributing member is removed from the composite content item, the former contributing member may be removed from the participant list. Further, the allocation guideline associated with the contributing participants may be dynamically adjusted according to a variety of factors, such as the addition of new contributing participants or the removal of former contributing participants.

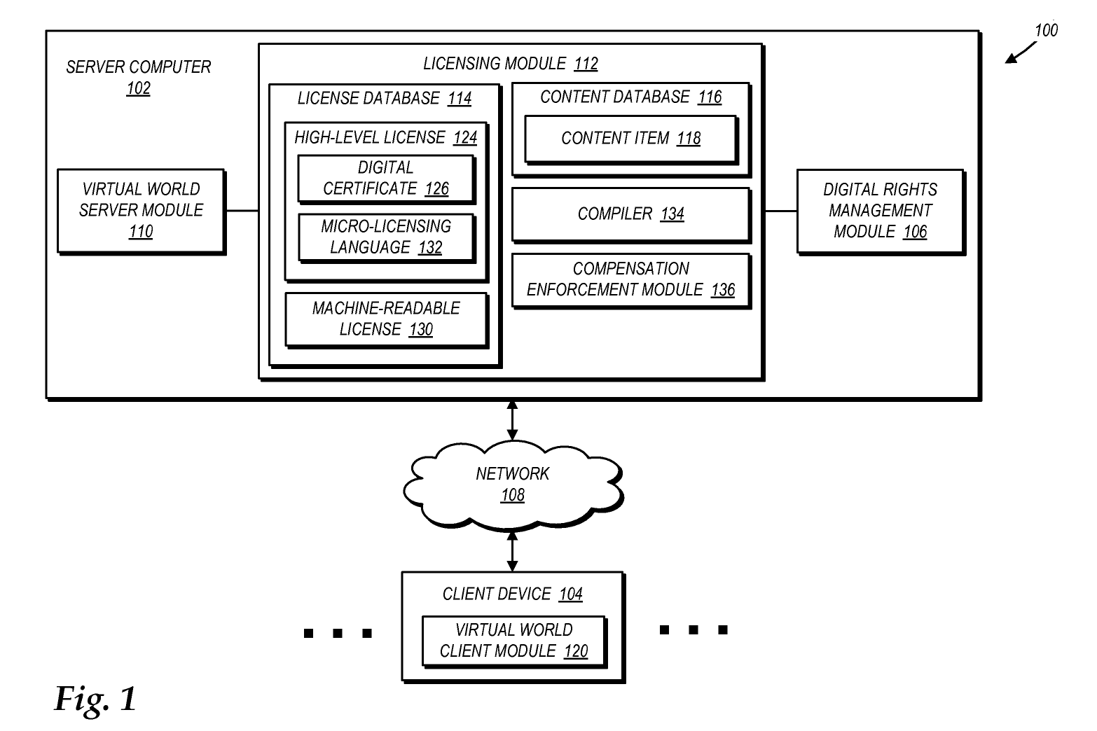

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing advertising in a virtual world will be described. In particular, FIG. 1 illustrates a simplified network architecture 100 for a virtual world. The network architecture 100 shown in FIG. 1 includes a server computer 102 and a client device 104, each of which is operatively coupled via a network 108. The network 108 may be any suitable network, such as a local area network (“LAN”) or the Internet. Although only one client device 104 is illustrated in FIG. 1, the network architecture 100 may include multiple client devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from virtual world server module 110 and output the data to output devices coupled to the client device 104. Further, the virtual world client module 120 may receive data from input devices coupled to the client device 104 and transmit the data to the virtual world server module 110.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

As shown in FIG. 1, the server computer 102 includes a virtual world server module 110, a licensing module 112, and a digital rights management (“DRM”) module 106. The virtual world server module 110 generally administers the virtual world and serves as a conduit between multiple client devices, including the client device 104. The licensing module 112 includes a license database 114, a content database 116, a compiler 134, and a compensation enforcement module 136. The content database 116 stores one or more participant-generated content items, such as a composite content item 118. In one embodiment, the composite content item 118 is uploaded from the client device 104 to the content database 116.

The license database 114 stores one or more licenses, such as a high-level and machine-independent representation of a license 124 (hereinafter referred to as “high-level license 124”). In one embodiment, the high-level license 124 is manually generated using, for example, a text editor. In another embodiment, the high-level license 124 is automatically generated using a software application, such as a licensing wizard (not shown). The high-level license 124 may include code in accordance with a suitable schema, such as Extensible Markup Language (“XML”) or a suitable high-level programming language, such as C. Other representations of the high-level license 124 may be contemplated by those skilled in the art.

The high-level license 124 may be partially or entirely disconnected from the server computer 102. In this way, the high-level license 124 may be portable without any reliance on the server computer 102. For example, the high-level license 124 may be stored on the client device 104 or other suitable device. To protect the integrity of the high-level license 124, the high-level license 124 may include a digital certificate 126 that is signed by a private key. In one embodiment, the digital certificate 126 includes signed digests of both the high-level license 124 and the composite content item 118. The private key may be generated by a trusted, central authority (e.g., the administrator of the virtual world) and stored in a secure location.

When a client application, such as the virtual world client module 120, accesses the high-level license 124, the client application may utilize a corresponding public key to verify the digital certificate 126. The digital certificate may be utilized to validate that the high-level license 124 has been approved by the central authority or other source, that the high-level license 124 has not been improperly changed, and that the high-level license 124 is cryptographically associated with the content described by the high-level license 124.

By separating the high-level license 124 from the server computer 102, offline (i.e., non-network) transactions involving the high-level license 124 become available. For example, after a first client application obtains the composite content item 118 via the server computer 102, the first client application also obtains the high-level license 124. Since the high-level license 124 includes the digital certificate 126, the first client application can present the composite content item 118 to a second client application offline. By utilizing the public key, the second client application can render the composite content item 118 to users while honoring the licensing terms of the high-level license 124.

Upon generating or uploading the high-level license 124, a compiler 134 may generate a machine-readable and enforceable representation of the license 130 (hereinafter referred to as “machine-readable license 130”) by compiling the high-level license 124 into object code. Alternatively, the high-level license 124 may be directly utilized without compiling the high-level license 124 into object code. The machine-readable license 130 may also be stored in the license database 114, as illustrated in FIG. 1, or in separate database (not shown). The machine-readable license 130 or the high-level license 124 may be utilized by any suitable machine managing the distribution and/or usage of the composite content item 118. For example, a content provider may utilize the machine-readable license 130 or the high-level license 124 to manage the sale of the composite content item 118 to other participants in the virtual world. The machine-readable license 130 or the high-level license 124 may also be utilized to manage which contributing participants are compensated upon the sale, rental, or lease of the composite content item 118.

In one embodiment, the enforcement of the licenses, such as the high-level license 124 and the machine-readable license 130, stored in the license database 114, with respect to distributing the composite content item 118, is facilitated by way of the digital rights management (“DRM”) module 106. In particular, DRM may be utilized to manage, among other distribution and usage factors, the number of computing devices that can access the composite content item 118, the number of times that the composite content item 118 can be accessed, the length of time for which the composite content item 118 can be accessed, the number of times that the composite content item 118 can be transferred, the number of times that the composite content item 118 can be copied, and the number of times that a computer-readable medium (e.g., CD-ROM, DVD-ROM) containing the composite content item 118 can be created. DRM may also determine the amount of money to be charged for performing these distribution and usage factors. It should be appreciated that other suitable methods for enforcing the licenses stored in the license database 114 may also be used.

In one embodiment, the DRM module 106 is a web server. An exemplary DRM process executed by the DRM module 106 may operate as follows for the composite content item 118 (e.g., a multimedia file). First, the DRM module 106 encrypts the composite content item 118 with a key. The encrypted composite content item 118 includes a uniform resource locator (“URL”) pointing to the DRM module 106. The encrypted composite content item 118 may be provided to the virtual world, and a participant may obtain the encrypted composite content item 118 at the client device 104. When the participant attempts to access the encrypted composite content item 118, the participant is directed to the DRM module 106 where the participant can purchase or otherwise obtain the high-level license 124 from the license database 114. If the participant agrees to the terms of the high-level license 124, the high-level license 124 may be copied to the client device 104. In this case, the high-level license 124 may include the key with which to unlock the encrypted composite content item 118. The participant may then access the composite content item 118 subject to the limitations set forth by the machine-readable and enforceable license 124 stored in the client device 104. It should be appreciated that the above described DRM process is merely illustrative. Other suitable DRM processes may be utilized as contemplated by those skilled in the art.

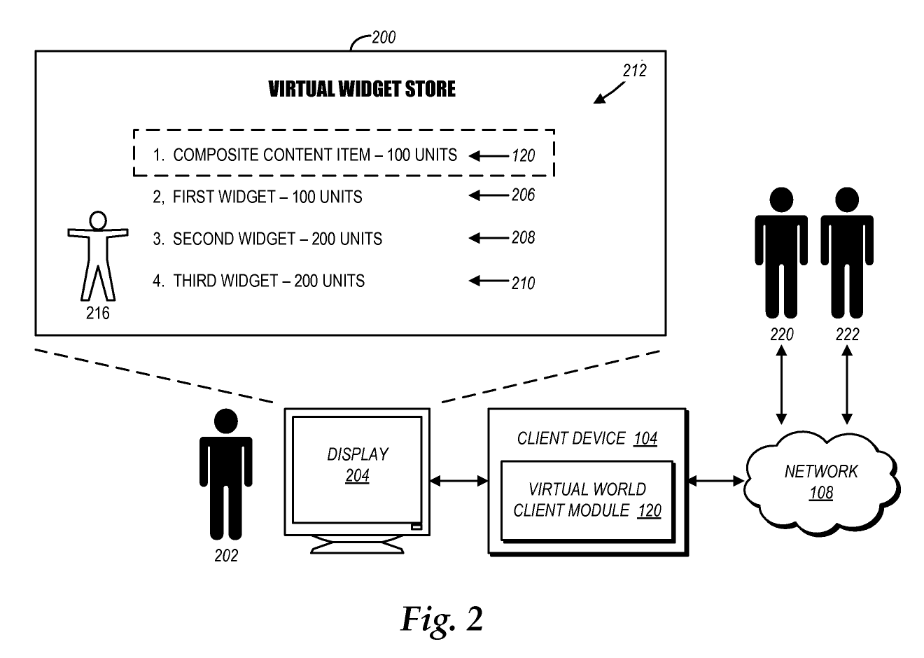

As previously mentioned, the high-level license 124 may dictate the distribution of compensation to the contributing participants who contribute to the generation and/or maintenance of the composite content item 118 or otherwise provides a portion of the composite content item. In particular, the micro-licensing language 132 specifies the contributing participants who are compensated, according to one embodiment. The micro-licensing language 132 may also specify the amount to compensate the contributing participants. In one embodiment, the micro-licensing language 132 is enforced by the compensation enforcement module 136. The operation of compensation enforcement module 136 is described in greater detail below with respect to FIGS. 2-4.

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110.

When a participant desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110.

Turning now to FIG. 2, an illustrative screenshot 200 of the virtual world provided by the virtual world server module 110 and the virtual world client module 120 is shown, in accordance with one embodiment. A purchasing participant 202 may view the screenshot 200 on a display 204 operatively coupled to the client device 104. The screenshot 200 illustrates a virtual widget store 212 selling a number of different items.

As shown in FIG. 2, the screenshot 200 includes an avatar 216 standing inside the virtual widget store 212. The avatar 216 is a fictional representation of the purchasing participant 202 in the virtual world. In one embodiment, the purchasing participant 202 controls the movement of the avatar 216 within the virtual world via an input device (not shown), such a keyboard, mouse, and game controller, operatively coupled to the client device 104. The purchasing participant 202 may utilize the avatar 216 to interact with other avatars (not shown) in the virtual world. As illustrated in the screenshot 200, the virtual widget store 212 sells the composite content item 118, a first widget 206, a second widget 208, and a third widget 210. The composite content item 118 and the first widget 206 sell for one hundred units of a given currency accepted in the virtual widget store 212. The second widget 208 and the third widget 210 sell for two hundred units of the given currency.

In an illustrative example, the purchasing participant 202 selects the composite content item 118 for purchase, rental, or lease. For example, the purchasing participant 202 clicks on the composite content item 118 using a mouse or other input device. In one embodiment, the composite content item 118 is generated and/or maintained by a first contributing participant 220 and a second contributing participant 222. As previously mentioned, the composite content item 118 may be associated with the high-level license 124. Upon the sale, rental, or lease of the composite content item 118 to the purchasing participant 202, at least a portion of the one hundred units paid is distributed to the first contributing participant 220 and the second contributing participant 222 according to the micro-licensing language 132 of the high-level license 124.

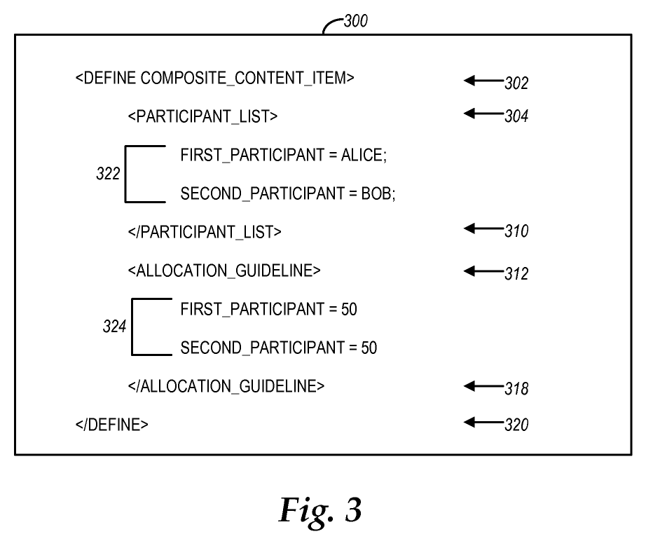

Turning now to FIG. 3, an illustrative block of pseudo-code 300 within the micro-licensing language 132 is shown, in accordance with one embodiment. In particular, the pseudo-code 300 illustrates the portion of the micro-licensing language 132 that defines the contributing participants who generate and/or maintain or otherwise provide a portion of the composite content item 118. Further, the pseudo-code 300 also defines the amount of compensation allocated to each of the contributing participants.

Referring to the pseudo-code 300, a first line 302 indicates the beginning of pseudo-code that defines the composite content item 118. A second line 304 indicates that the beginning of pseudo-code that defines a participant list 322. The participant list 322 defines two contributing participants: Alice, who is the first contributing participant 220; and Bob, who is the second contributing participant 222. In one embodiment, the participant list 322 defines the contributing participants who are compensated for the sale, rental, or lease of the composite content item 118. The participant list 322 may identify the contributing participants by a user identification number or other suitable identifier. A fifth line 310 indicates the end of the participant list 322.

A sixth line 312 indicates that the beginning of pseudo-code that defines an allocation guideline 324. In the illustrative example of FIG. 3, the allocation guideline 324 specifies that the first contributing participant 220 and the second contributing participant 222 each receive fifty percent of a given amount of compensation to be provided. In another embodiment, the allocation guideline 324 may specify predetermined amounts of compensation. The allocation guideline 324 may be based on a variety of factors, such as the amount of contribution by the contributing participants as well as the importance or impact of the contributions. A ninth line 318 line indicates the end of the allocation guideline 324. A tenth line 320 indicates the end of the pseudo-code 300.

According to exemplary embodiments, the participant list 322 and the allocation guideline 324 may be adjusted to account for changes to the contributing participants, changes to the amount contributed by the contributing participants, and other relevant factors. In one example, if a third contributing participant (not shown) provides an improvement to the composite content item 118, then the third contributing participant may be added to the participant list 322 and the allocation guideline 324. In another example, if either first contributing participant 220 desires not to participate in the maintenance of the composite content item 118 or the portion of the composite content item 118 generated by the first contributing participant 220 is removed, then the first contributing participant 220 may be removed from the participant list 322.

In one embodiment, the micro-licensing language 132 is in the form of a schema, such as XML schema or other suitable schema language. In other embodiments, the micro-licensing language 132 may be in the form of a high-level programming language, such as C. Other representations of the micro-licensing language 132 may be contemplated by those skilled in the art.

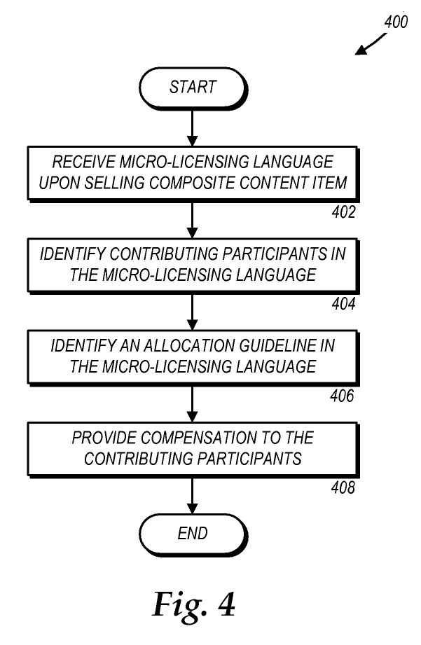

Turning now to FIG. 4, additional details will be provided regarding the micro-licensing language 132 within the high-level license 124. In particular, FIG. 4 is a flow diagram illustrating aspects of one method provided herein for enforcing the micro-licensing language 132 for compensating contributing participants. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 4, a routine 400 begins at operation 402, where the compensation enforcement module 136 receives the micro-licensing language 132 upon the sale, rental, or lease of the composite content item 118. In one embodiment, the micro-licensing language 132 or the high-level license 124 is transmitted to the compensation enforcement module 136. In another embodiment, the micro-licensing language 132 or the high-level license 124 is retrieved from the license database 114 upon notification of the composite content item 118. The micro-licensing language 132 or the high-level license 124 may be associated with one or more composite content items. If the compensation enforcement module 136 receives the high-level license 124, the compensation enforcement module 136 may extract or otherwise access the micro-licensing language 132 within the high-level license 124. Upon receiving the micro-licensing language 132, the routine 400 continues to operation 404.

In one embodiment, the micro-licensing language 132 includes a participant list 322, which specifies one or more contributing participants who contributed to the generation and/or maintenance of the composite content item 118 or otherwise provides a portion of the composite content item. That is, the participant list 322 identifies the contributing participants to be compensated upon the sale, rental, or lease of the composite content item 118. At operation 404, the compensation enforcement module 136 identifies the contributing participants, such as the first contributing participant 220 and the second contributing participant 222, listed in the participant list 322. Upon identifying the contributing participants, the routine 400 continues to operation 406.

In one embodiment, the micro-licensing language 132 further includes the allocation guideline 324, which specifies the allocation of compensation to the contributing participants. At operation 406, the compensation enforcement module 136 identifies the allocation guideline 324. Examples of the allocation guideline 324 may include a predetermined amount of compensation or a percentage of an overall amount. The routine 400 continues to operation 408, where the compensation enforcement module 136 provides compensation to the contributing participants in accordance with the participant list 322 and the allocation guideline 324. For example, if the participant list 322 specifies the first contributing participant 220 and the second contributing participant 222, and the allocation guideline 324 specifies an even split in the proceeds from the sale, rental, or lease of the composite content item 118, then the first contributing participant 220 and the second contributing participant 222 each receive an equal amount of compensation.

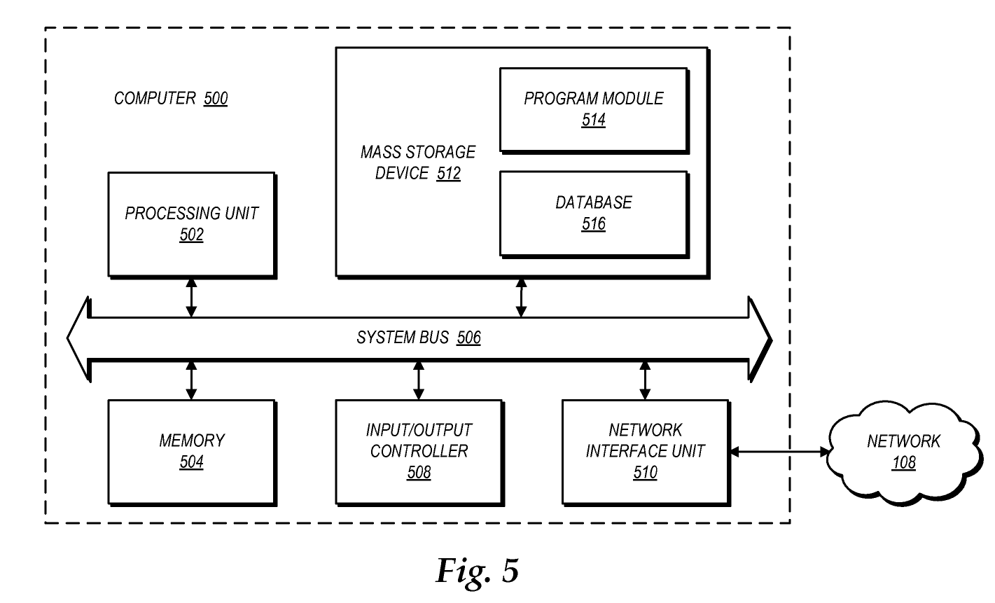

Referring now to FIG. 5, an exemplary computer architecture diagram showing aspects of a computer 500 is illustrated. Examples of the computer 500 may include the server computer 102 and the client device 104. The computer 500 includes a processing unit 502 (“CPU”), a system memory 504, and a system bus 506 that couples the memory 504 to the CPU 502. The computer 500 further includes a mass storage device 512 for storing one or more program modules 514 and one or more databases 516. Examples of the program modules 514 may include the licensing module 112, the compiler 134, and the compensation enforcement module 136. Examples of the databases 516 may include the license database 114 and the content database 116. The mass storage device 512 is connected to the CPU 502 through a mass storage controller (not shown) connected to the bus 506. The mass storage device 512 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available computer storage media that can be accessed by the computer 500.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network such as the network 108. The computer 500 may connect to the network 108 through a network interface unit 510 connected to the bus 506. It should be appreciated that the network interface unit 510 may also be utilized to connect to other types of networks and remote computer systems. The computer 500 may also include an input/output controller 508 for receiving and processing input from a number of input devices (not shown), including a keyboard, a mouse, a microphone, and a game controller. Similarly, the input/output controller 508 may provide output to a display or other type of output device (not shown).

Based on the foregoing, it should be appreciated that technologies for generating and enforcing micro-licensing language for compensating multiple contributing participants are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for compensating multiple contributing participants in a virtual world, the method comprising:
receiving a license associated with a composite content item upon a sale, rental, or lease of the composite content item to a purchasing participant in the virtual world;
identifying at least a first contributing participant and a second contributing participant in a participant list within the license; and
providing compensation to the first contributing participant and the second contributing participant in accordance with the participant list.

2. The method of claim 1, further comprising identifying an allocation guideline within the license; and
wherein providing compensation to the first contributing participant and the second contributing participant in accordance with the participant list comprises:
providing compensation to the first contributing participant and the second contributing participant in accordance with the participant list and the allocation guideline.

3. The method of claim 2, wherein the allocation guideline identifies a first value associated with the first contributing participant and a second value associated with the second contributing participant; and
wherein providing compensation to the first contributing participant and the second contributing participant in accordance with the participant list and the allocation guideline comprises:
providing a first amount of compensation to the first contributing participant in accordance with the first value; and
providing a second amount of compensation to the second contributing participant in accordance with the second value.

4. The method of claim 3, wherein the first value and the second value comprises one of a percentage or a predetermined amount.

5. The method of claim 1, wherein the license comprises source code written in a markup language.

6. The method of claim 1, wherein the license comprises source code written in a high-level programming language.

7. The method of claim 1, wherein the license comprises machine-readable object code.

8. The method of claim 1, wherein the composite content item comprises a first portion generated by the first contributing participant and a second portion generated by the second contributing participant.

9. The method of claim 1, wherein the composite content item comprises a first portion maintained by the first contributing participant and a second portion maintained by the second contributing participant.

10. A method for compensating multiple contributing participants in a virtual world, the method comprising:
receiving a micro-licensing portion of a license associated with a composite content item upon a sale, rental, or lease of the composite content item to a purchasing participant in the virtual world, the micro-licensing portion comprising a participant list and an allocation guideline;
identifying at least a first contributing participant and a second contributing participant in the participant list;
identifying an allocation guideline for the first contributing participant and the second contributing participant; and
providing compensation to the first contributing participant and the second contributing participant in accordance with the participant list and the allocation guideline.

11. The method of claim 10, wherein the allocation guideline identifies a first value associated with the first contributing participant and a second value associated with the second contributing participant; and
wherein providing compensation to the first contributing participant and the second contributing participant in accordance with the participant list and the allocation guideline comprises:
providing a first amount of compensation to the first contributing participant in accordance with the first value; and
providing a second amount of compensation to the second contributing participant in accordance with the second value.

12. The method of claim 11, wherein the first value and the second value comprises one of a percentage or a predetermined amount.

13. The method of claim 10, wherein the micro-licensing language comprises source code written in a markup language.

14. The method of claim 10, wherein the micro-licensing language comprises source code written in a high-level programming language.

15. The method of claim 10, wherein the micro-licensing language comprises machine-readable object code.

16. The method of claim 10, wherein the composite content item comprises a first portion generated by the first contributing participant and a second portion generated by the second contributing participant.

17. The method of claim 10, wherein the composite content item comprises a first portion maintained by the first contributing participant and a second portion maintained by the second contributing participant.

18. A computer-readable medium having computer-executable instructions stored thereon which, when executed by a computer, cause the computer to:
providing a composite content item for sale, rental, or lease, the composite content item comprises a first portion associated with a first contributing participant and a second portion associated with a second contributing participant;
upon the sale, rental, or lease of the composite content item to a purchasing participant of a virtual world, receiving a micro-licensing portion of a license associated with the composite content item, the micro-licensing portion comprising a participant list and an allocation guideline;
identifying at least a first contributing participant and a second contributing participant in the participant list;
identifying the allocation guideline for the first contributing participant and the second contributing participant, the allocation guideline specifying a first value associated with the first contributing participant and a second value associated with the second contributing participant;
providing a first amount of compensation to the first contributing participant in accordance with the participant list and the first value; and
providing a second amount of compensation to the second contributing participant in accordance with the participant list and the second value.

19. The computer-readable medium of claim 18, wherein the first portion is generated by the first contributing participant and the second portion is generated by the second contributing participant.

20. The computer-readable medium of claim 18, wherein the first portion is maintained by the first contributing participant and the second portion is maintained by the second contributing participant.
